(19) United States
(12) Patent Application Publication
(10) Pub. No.: US 2016/0057199 A1
(43) Pub. Date: Feb. 25, 2016

(54) SYSTEMS AND METHODS FOR TRANSMITTING A MEDIA FILE IN MULTIPLE PORTIONS

(71) Applicant: Facebook, Inc., Menlo Park, CA (US)

(72) Inventors: Omid Aziz, San Francisco, CA (US); Paul Francois Carduner, Seattle, WA (US); Ankur Dahiya, San Francisco, CA (US)

(21) Appl. No.: 14/465,700

(22) Filed: Aug. 21, 2014

(51) Int. Cl. H04L 29/08; H04L 12/58

(52) U.S. Cl. CPC H04L 67/06; H04L 51/32

(57) ABSTRACT

Systems, methods, and non-transitory computer-readable media can receive an initial request to upload a media file. A first portion size for the media file can be determined based on information included in the initial request. A first data start position and a first data end position for the media file can be transmitted based on the first portion size. A first portion of the media file can be received. In some instances, the first portion can be acquired from the media file based on the first data start position and the first data end position.

### FIELD OF THE INVENTION

The present technology relates to the field of data transmission. More particularly, the present technology relates to techniques for transmitting a media file in multiple portions.

### BACKGROUND

Today, people utilize computing devices (or systems) for various purposes. Users can use their computing devices to interact with one another, access content, create content, and share content. Various systems or services can enable users to provide content, such as by allowing the users to upload files. In some cases, a social networking system (or service) can provide a medium for users of the social networking system to upload content, such as one or more media files.

In one example, a user may desire to use his or her computing device (or system) to upload a media file, such as a video file. Under conventional approaches, the uploading can be unreliable and inefficient. The user's computing device may be experiencing network connectivity issues, such as not having a sufficient level of cellular reception. As such, the uploading of the video file can fail many times. Furthermore, the user may not have an unlimited data plan, such that each retry to upload the video file causes more data to be used up under the user's data plan. These and other concerns associated with conventional approaches can create challenges for and reduce the overall user experience associated with transmitting files.

### SUMMARY

Various embodiments of the present disclosure can include systems, methods, and non-transitory computer readable media configured to receive an initial request to upload a media file. A first portion size for the media file can be determined based on information included in the initial request. A first data start position and a first data end position for the media file can be transmitted based on the first portion size. A first portion of the media file can be received. In some instances, the first portion can be acquired from the media file based on the first data start position and the first data end position.

In an embodiment, the information included in the initial request can comprise at least one of a file size of the media file, a network condition, historical usage data, or a property associated with a source requesting to upload the media file.

In an embodiment, the network condition can indicate bandwidth. In some cases, the first portion size for the media file can be increased when the bandwidth increases and the first portion size for the media file can be decreased when the bandwidth decreases.

In an embodiment, the first portion size can be determined based on historical usage data including information about a portion size during a previous file upload.

In an embodiment, the property associated with the source can include at least one of a property about an operating system of the source or a property about an application running on the source.

In an embodiment, a second portion size for the media file can be determined. A second data start position and a second data end position for the media file can be transmitted based on the second portion size. In some cases, the second data start position can correspond to a data position in the media file equal or subsequent to the first data end position. A second portion of the media file can be received. The second portion can be acquired from the media file based on the second data start position and the second data end position.

In an embodiment, one or more validation processes can be performed for at least one of the initial request, the first portion of the media file, or the second portion of the media file.

In an embodiment, the one or more validation processes can be performed at a source requesting to upload the media file.

In an embodiment, the one or more validation processes can utilize at least one of a feature associated with FFmpeg or a MOOV atom of the media file.

In an embodiment, it can be determined that the media file has been received entirely. A message indicating that the media file has been received entirely can be transmitted. A request to post the media file can be received.

In an embodiment, the media file can be encoded. The media file can be posted at a social networking system under an account associated with a source requesting to upload the media file.

In an embodiment, a second portion size for the media file can be determined. A second data start position and a second data end position for the media file can be transmitted. The second data start position and the second data end position can be based on the second portion size. The second data start position can correspond to a data position in the media file equal or subsequent to the first data end position. An error associated with a transmission of the second portion of the media file can be detected.

In an embodiment, it can be determined that a sub-portion of the second portion of the media file has been received. The sub-portion of the second portion of the media file can be stored. A third data start position equal or subsequent to a data end position of the sub-portion can be transmitted. A remainder portion of the second portion of the media file can be received. The sub-portion and the remainder portion can be combinable to produce to the second portion of the media file.

In an embodiment, the error can be associated with at least one of an error code, an error sub-code, an error message, an error title, a transient error flag, or a permanent error flag.

In an embodiment, it can be determined that the error associated with the transmission of the second portion is permanent. A message indicating that the transmission of the second portion has incurred a permanent error can be transmitted.

In an embodiment, it can be determined that the error associated with the transmission of the second portion is transient. A resume request to continue uploading the media file can be received. The second data start position and the second data end position can be transmitted. The second portion of the media file can be received.

In an embodiment, the resume request can be received. In some cases, the resume request can be based on an exponential back-off algorithm.

In an embodiment, the media file can include at least one of a video file, an image file, an audio file, or a media software file.

Many other features and embodiments of the invention will be apparent from the accompanying drawings and from the following detailed description.

### BRIEF DESCRIPTION OF THE DRAWINGS

FIG. 1 illustrates an example system including an example client computing system and an example server computing system configured to facilitate transmitting a media file in multiple portions, according to an embodiment of the present disclosure.

FIG. 2 illustrates an example file portion transmission module configured to facilitate transmitting a media file in multiple portions, according to an embodiment of the present disclosure.

FIG. 3 illustrates an example processing module configured to facilitate transmitting a media file in multiple portions, according to an embodiment of the present disclosure.

FIG. 4 illustrates an example portion size module configured to facilitate transmitting a media file in multiple portions, according to an embodiment of the present disclosure.

FIG. 5 illustrates an example validation module configured to facilitate performing validations associated with transmitting a media file in multiple portions, according to an embodiment of the present disclosure.

FIG. 6 illustrates an example error handling module configured to facilitate handling errors associated with transmitting a media file in multiple portions, according to an embodiment of the present disclosure.

FIG. 7 illustrates an example method associated with transmitting a media file in multiple portions, according to an embodiment of the present disclosure.

FIG. 8 illustrates an example method associated with transmitting a media file in multiple portions, according to an embodiment of the present disclosure.

FIG. 9 illustrates a network diagram of an example system that can be utilized in various scenarios, according to an embodiment of the present disclosure.

FIG. 10 illustrates an example of a computer system that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Transmitting a Media File in Multiple Portions

People use computing devices (or systems) for a wide variety of purposes. Users can utilize their computing devices to interface with a social networking system (or service) to establish connections, communicate, and interact with one another via the social networking system. Users can also utilize their computing devices to create, access, and share various types of content. In some cases, the social networking system can provide a medium through which various types of content and files are created, accessed, and/or shared.

In some cases, users may desire to upload content, such as one or more media files. Examples of media files can include, but are not limited to, video files, image files, audio files, game files, and/or other media software files. In accordance with conventional approaches, a user may utilize his or her computing device to transmit or upload an entire video file during a single transmission. However, when network conditions are undesirable (e.g., insufficient cellular reception, intermittent cellular service coverage, etc.), the uploading of the entire video file during the single transmission can fail. As such, many retries can be performed in attempt to upload the video file. This can be time-consuming, troublesome, and frustrating for the user. Moreover, in the case that the user does not have an unlimited data plan, the retrying of the video file upload can inefficiently use up data under the user's data plan. Accordingly, these and other concerns associated with conventional approaches can create challenges for and reduce the overall user experience associated with transmitting files.

Therefore, an improved approach to transmitting files can be beneficial for addressing or alleviating various concerns associated with conventional approaches. Various embodiments of the present disclosure can, for example, receive an initial request to upload a media file, such as a video file. A first portion size for the media file can be determined based on information included in the initial request. In some cases, a file portion can also be referred to as a chunk. A first data start position and a first data end position for the media file can be transmitted based on the first portion size. A first portion of the media file, acquired from the media file based on the first data start position and the first data end position, can be received.

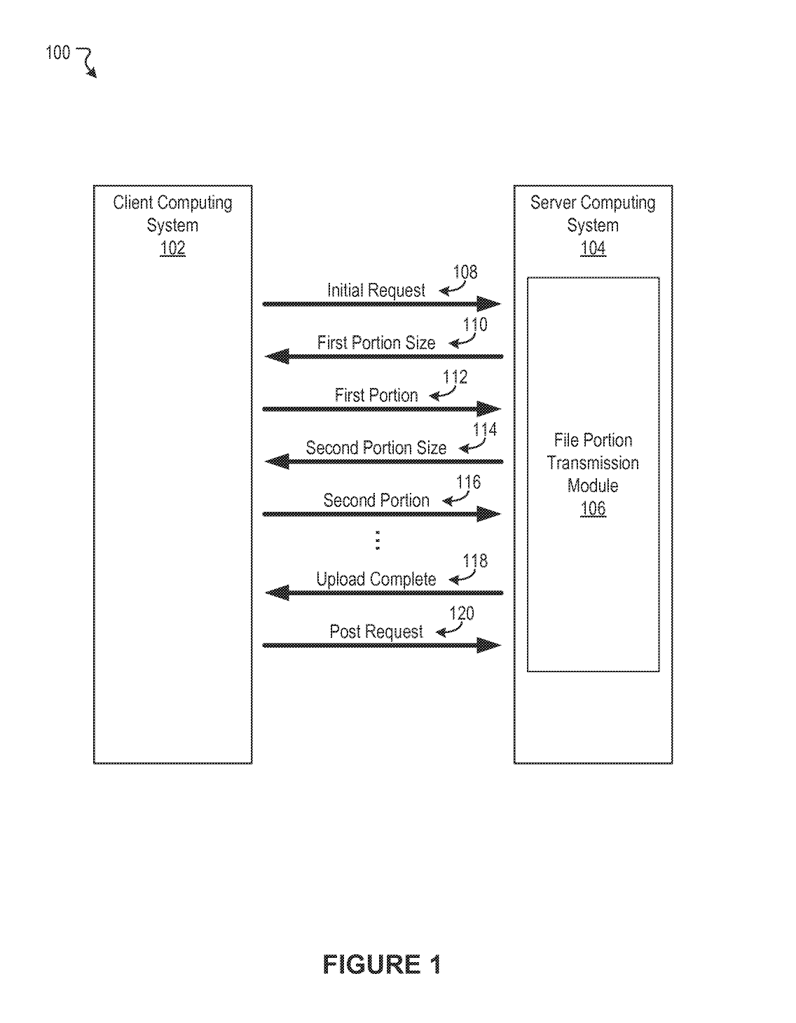

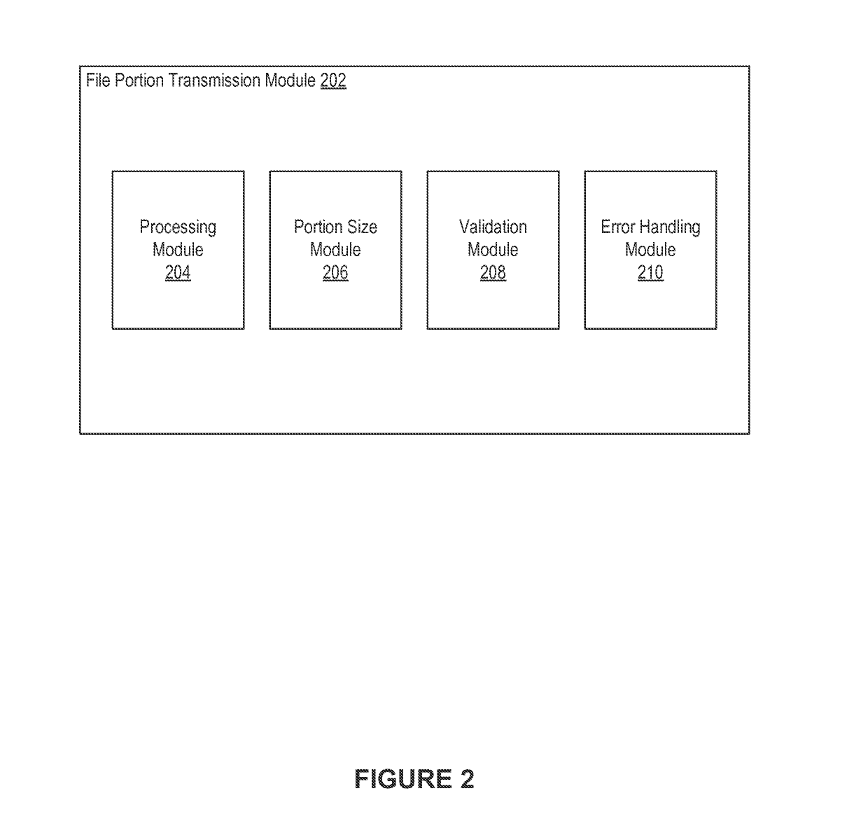

FIG. 1 illustrates an example system 100 including an example client computing system 102 and an example server computing system 104 configured to facilitate transmitting a media file in multiple portions, according to an embodiment of the present disclosure. In some implementations, the example server computing system 104 can include a file portion transmission module 106 configured to perform various tasks and operations associated with transmitting media files in multiple portions. The file portion transmission module 106 will be discussed in more detail with reference to FIG. 2.

In the example of FIG. 1, the client computing system 102 can transmit an initial request 108 to upload or send a media file, such as a video file. A video file can generally have a larger data file size, such as when compared to an image file. Accordingly, uploading the entire video during a single transmission file can cause problems, as discussed previously. As such, the server computing system 104 (or the file portion transmission module 106 running on the server 104) can cause the video file to be transmitted or uploaded from the client 102 in multiple portions or chunks.

Continuing with the example, the server 104 can determine a first portion size that is suitable or appropriate for the video file. In some cases, the determination of the first portion size can be based on the video file, the client 102, network conditions, and/or various other factors. For example, if the video file is less than a specified threshold file size, then the video file can be transmitted in a few portions and each portion can be substantial in size relative to the file size of the entire video file. In another example, portion sizes can be determined based on what operating system the client 102 is running and/or what kind of computing system (or device) the client 102 is. In some embodiments, an optimal portion size can be determined for each of the various operating systems and/or client systems. In a further example, unreliable network conditions can cause the portion sizes to be decreased, whereas reliable network conditions can cause the portion sizes to be increased.

Upon determining the first portion size, the server 104 can transmit the first portion size 110 to the client 102. In some cases, the first portion size can include a first data start position and a first data end position. For example, if the first portion size is 10 Megabyte, then the first data start position can correspond to the first Megabyte (or first Kilobyte, first byte, etc.) and the first data end position can correspond to the 10^{th} Megabyte (or 10,000^{th} Kilobyte, 10,240^{th} Kilobyte, 10,000,000^{th} byte, 10,485,760^{th} byte, etc.). Based on the first portion size, the client 102 can apportion, split, and/or slice, etc., the video file into portions. To accomplish this task, in some embodiments, the client 102 can utilize a slicing feature or tool in HTML5. Having apportioned, split, and/or sliced the video file, the client 102 can transmit or upload a first portion 112 of the video file to the server 104.

In some embodiments, the server 104 can validate the first portion of the video file, which will be discussed in more detail below. The server 104 can determine or calculate the next portion size, a second portion size. In some cases, the second portion size can be the same as the first portion size. In some instances, the second portion size can be different from the first portion size. For example, if the network conditions have improved, then the second portion size can be increased such that the second portion size is greater than the first portion size. Having determined the second portion size, a transmission of the second portion size 114 to the client 102 can be performed by the server 104.

The client 102 can receive the second portion size. The second portion size can include a second data start position and a second data end position. In some cases, the second data start position can correspond to the first data end position, such that the first portion of the video file and a second portion are continuous. In some cases, if all portion sizes (e.g., the first and second portion sizes) are the same, then the client 102 can have already apportioned, split, and/or sliced, etc., the video file into portions with the same, or substantially similar, sizes. In some cases, if the portions sizes are different (e.g., the second portion size is different from the first portion size), then the client 102 can apportion, split, and/or slice, etc., the video file again to obtain the second portion. The client 102 can transmit or upload the second portion 116 to the server 104.

In some implementations, the server 104 can validate the second portion of the video file. Furthermore, the process of determining and transmitting a next portion size and receiving a next portion can repeat until the entire video file has been uploaded. When the entire video file has been uploaded, the server 104 can send a message 118 to the client 102 indicating that the upload is complete. In some cases, the client 104 can send a request 120 to post or publish the video file.

FIG. 2 illustrates an example file portion transmission module 202 configured to facilitate transmitting a media file in multiple portions, according to an embodiment of the present disclosure. In some instances, the file portion transmission module 106 of FIG. 1 can be implemented as the example file portion transmission module 202. As shown in FIG. 2, the example file portion transmission module 202 can include a processing module 204, a portion size module 206, a validation module 208, and an error handling module 210.

The processing module 204 can be configured to perform various tasks and/or operations associated with transmitting media files in multiple portions. In some implementations, the processing module 204 can receive an initial request to upload a media file. For example, a client can request to upload a video file.

In some embodiments, the portion size module 206 can be configured to determine a first portion size for the media file based on information included in the initial request. The information can include, but is not limited to, a file size of the media file, a network condition, historical usage data, and/or a property associated with a source (e.g., the client) requesting to upload the media file.

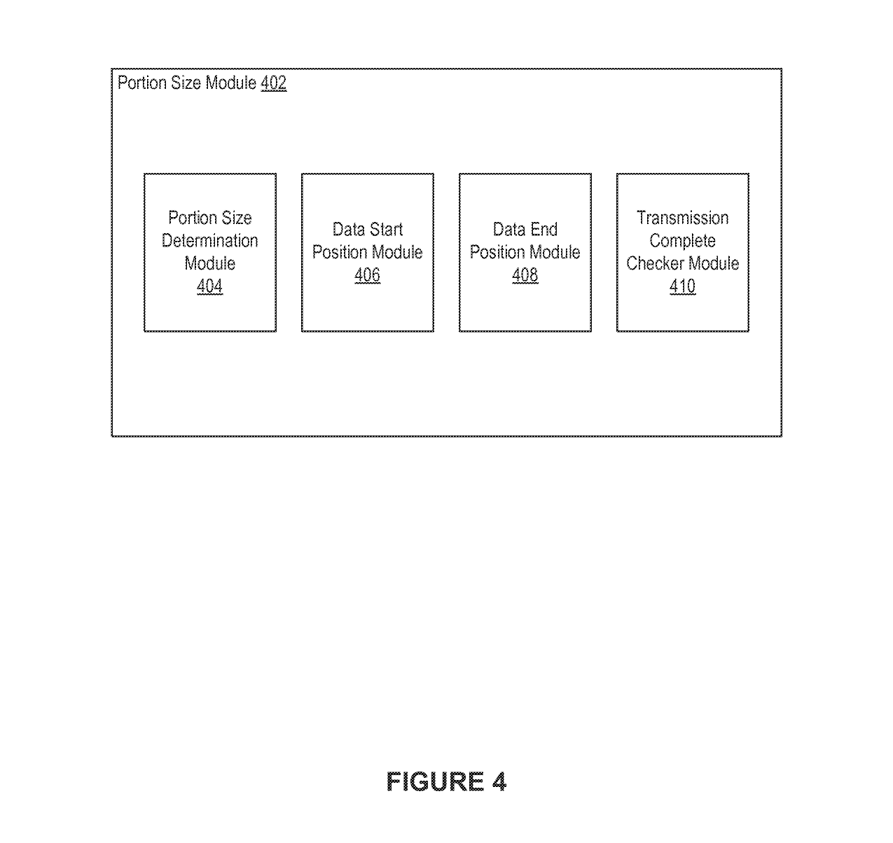

In one example, the network condition can indicate bandwidth, such as an amount of bandwidth available to the client and/or server during the uploading of the media file. The portion size module 206 can increase the first portion size for the media file when the bandwidth increases (e.g., or at least meets a specified bandwidth threshold). The portion size module 206 can decrease the first portion size for the media file when the bandwidth decreases (e.g., or is below the specified bandwidth threshold). In another example, the portion size module 206 can determine the first portion size based on historical usage data. If another media file was successfully and efficiently uploaded during a previous file upload, then the portion size module 206 can cause the first portion size to be the same as (or substantially similar to) a portion size used during the previous file upload. In a further example, the property associated with the source (e.g., client) can include a property about an operating system of the source and/or a property about an application running on the source. In some cases, an optimal portion size can be determined for the operating system and/or application. The portion size module 206 can cause the first portion size to be the same as (or substantially similar to) the optimal portion size. More details will provided for the portion size module 206 with reference to FIG. 4.

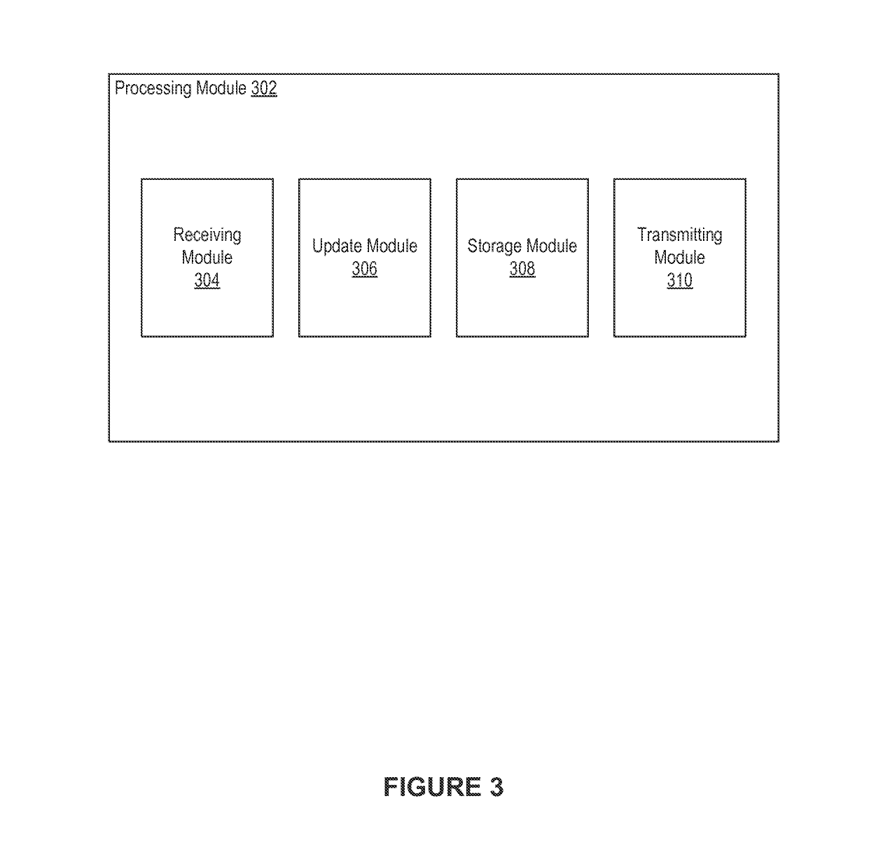

Additionally, in some instances, a first data start position and a first data end position for the media file can be based on the first portion size. The first data start position and the first data end position can, for example, be transmitted by the processing module 204 to the source (e.g., the client) that is requesting to upload the media file. In some cases, the processing module 204 can also be configured to receive a first portion of the media file, such as from the source. The first portion can be acquired from the media file based on the first data start position and the first data end position. For example, the client can utilize a slicing tool to apportion and obtain the first portion from the media file. More details regarding the processing module 204 will provided below with reference to FIG. 3.

In some instances, a second portion size for the media file can be determined by the portion size module 206. A second data start position and a second data end position based on the second portion size can be transmitted by the processing module 204. The second data start position can correspond to a data position in the media file equal or subsequent to the first data end position. Furthermore, the processing module 204 can receive a second portion of the media file, which can be acquired from the media file based on the second data start position and the second data end position.

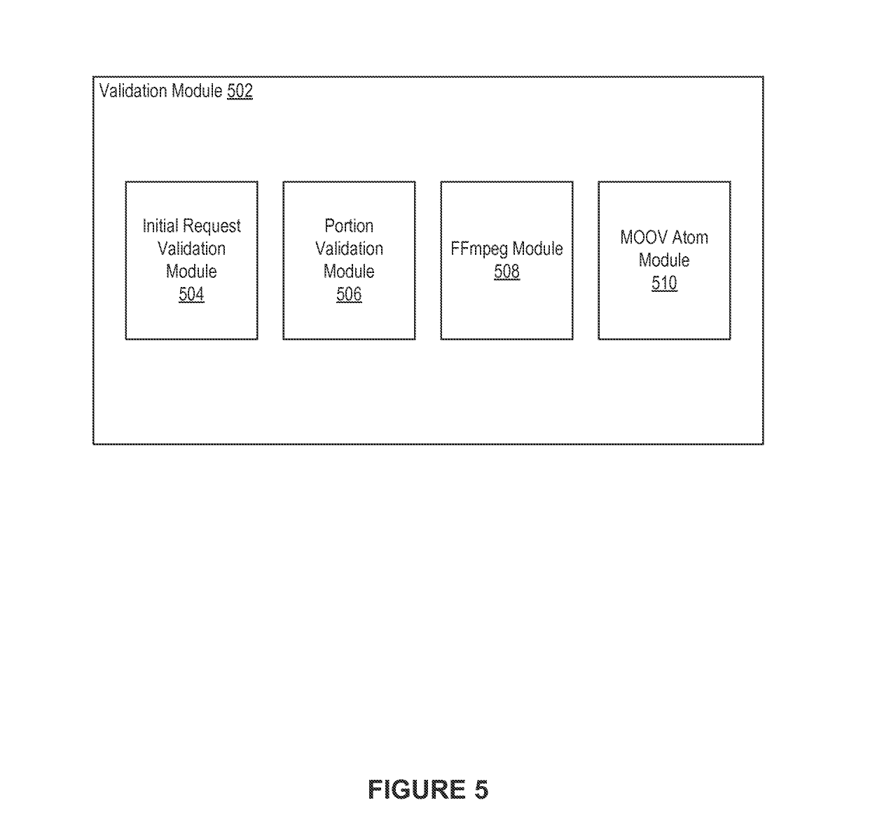

Moreover, in some embodiments, the validation module 208 can be configured to perform one or more validation processes. The one or more validation processes can be performed with respect to the initial request to upload the media file and/or with respect to a media file portion that is received. The validation module 208 will be discussed in more detail below with reference to FIG. 5.

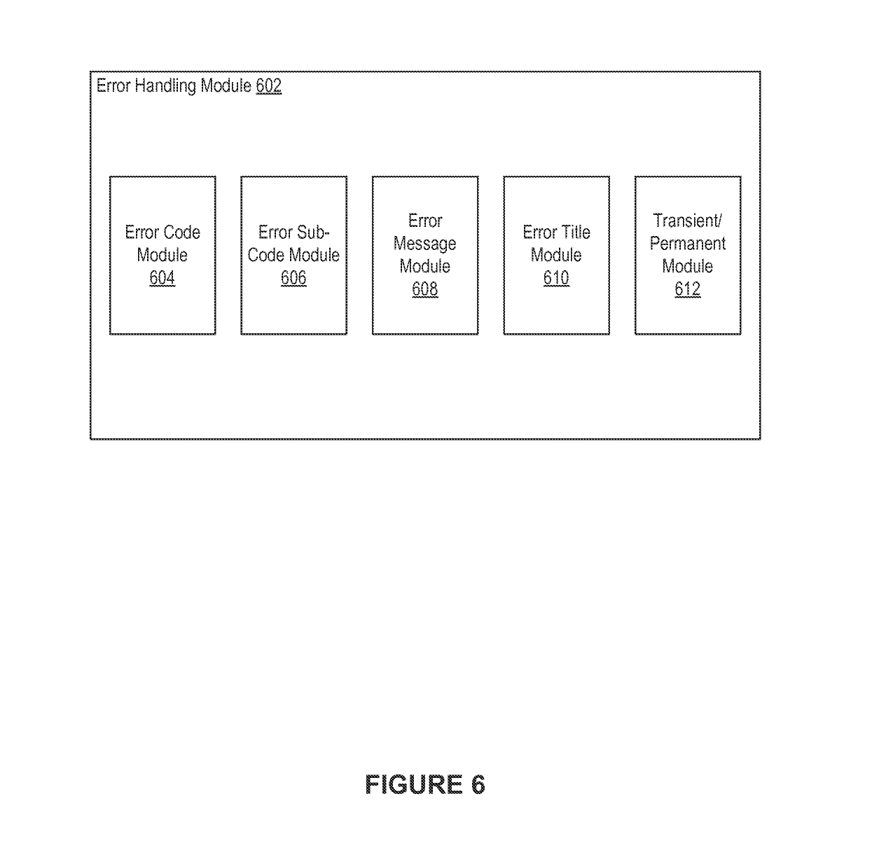

In some embodiments, the error handling module 210 can be configured to handle one or more errors associated with transmitting media files in multiple portions. The error handling module 210 will be discussed in more detail below with reference to FIG. 6.

FIG. 3 illustrates an example processing module 302 configured to facilitate transmitting a media file in multiple portions, according to an embodiment of the present disclosure. In some cases, the processing module 204 of FIG. 2 can be implemented as the example processing module 302. The example processing module 302 can include a receiving module 304, an update module 306, a storage module 308, and a transmitting module 310.

As discussed above, the receiving module 304 can be configured to receive an initial request to upload a media file, such as a video file. The processing module 302 can create a media file session, such as a video session, in response to the receiving of the initial request. In some instances, a media file session can correspond to an interactive information interchange, also referred to as a dialogue, a conversation, or a meeting, etc., between communicating devices or systems, such as between a client and a server. The media file session can be set up or established to facilitate the transmission or uploading of the media file, and then terminated or torn down after the transmission or upload is complete.

Moreover, in response to the initial request, the processing module 302 can also create an instance and/or container for the media file to be uploaded. The uploading can utilize the instance and/or container to produce a copy of the media file. In some embodiments, the update module 306 can be configured to update various types of data, such as information associated with the initial request. In some implementations, the storage module 308 can be configured to store various types of data, such as the information included in the initial request.

Furthermore, the processing module 302 can determine a portion size for a next media file portion to be uploaded. After the next portion size has been determined, the transmitting module 310 can be configured to transmit the next portion size. In some cases, the transmitting module 310 can transmit a next data start position and a next data end position based on the next portion size. The receiving module 304 can receive the next media file portion as well as each new media file portion afterwards (if any).

The update module 306 can update information associated with each new media file portion received. The storage module 308 can store each new media file portion received. When the final media file portion has been successfully received, the previous file portions stored by the storage module 308 can be combined to produce the copy of the media file.

It is understood that many variations are possible. In addition, it should be appreciated that, in some implementations, the receiving module 304 and the transmitting module 310 can be associated with a single transceiver module.

FIG. 4 illustrates an example portion size module 402 configured to facilitate transmitting a media file in multiple portions, according to an embodiment of the present disclosure. In some instances, the portion size module 206 of FIG. 2 can be implemented as the example portion size module 402. As shown, the example portion size module 402 can include a portion size determination module 404, a data start position module 406, a data end position module 408, and a transmission complete checker module 410.

The portion size determination module 404 can be configured to determine or calculate a next portion size for a media file to be uploaded. In some embodiments, the portion size can be determined to be constant or substantially constant. For example, if it is determined that a constant portion size of 5 MB is optimal for a particular video file that is 20 MB, then four portions of 5 MB each can be uploaded. If the particular video file is 21 MB, then there can be four portions of 5 MB and one portion of 1 MB (e.g., a final 1 MB portion).

The portion size determination module 404 can determine or calculate an initial portion size for the media file based on information included in an initial request to upload the media file. The information in the initial request can include, for example, a file size of the media file, a network condition, historical usage data, and/or a property associated with a source requesting to upload the media file, etc. In some embodiments, the network condition can indicate bandwidth. The initial portion size for the media file can be increased by the portion size determination module 404 when the bandwidth increases, and the initial portion size for the media file can be decreased by the portion size determination module 404 when the bandwidth decreases. Also, in some embodiments, the portion size determination module 404 can determine the initial portion size based on historical usage data including information about a portion size during a previous file upload. Furthermore, in some embodiments, the portion size determination module 404 can determine the initial portion size based on a property about an operating system of the source and/or a property about an application running on the source.

The data start position module 406 can be configured to determine or calculate a data start position, such as based on a given portion size. The data end position module 408 can be configured to determine or calculate a data end position, such as based on the given portion size. With respect to the initial portion size, the data start position module 406 can determine an initial data start position to be the first byte (or KB, MB, etc.) of the media file (or the start of the first byte of the media file), and the data end position module 408 can determine an initial data end position to correspond with the initial portion size. For example, a first portion size of a video file can be determined to be 5 MB. As such, in this example, the first data start position can correspond to the first MB of the video file (or the start of the first byte of the video file), while the first data end position can correspond to the fifth MB of the video file (or the end of the fifth MB of the video file). Moreover, a next data start position can correspond to a data position in the media file equal or subsequent to a previous data end position, while a next data end position can be determined based on an addition of a next portion size. Continuing with the previous example, a second portion size of the video file can also be 5 MB. The second data start position can correspond to the fifth MB of the video file (or the end of the fifth MB of the video file) and the second data end position can correspond to the 10^{th} MB of the video file (or the end of the 10^{th} MB of the video file).

Additionally, in some implementations, the portion size module 402 can optionally include the transmission complete checker module 410. The transmission complete checker module 410 can check or determine whether the transmission of the entire media file is complete or not. In one example, the transmission complete checker module 410 can check if a currently determined data start position is the same as a currently determined data end position. In another example, the transmission complete checker module 410 can check whether or not a currently determined data end position corresponds to the file size of the entire media file.

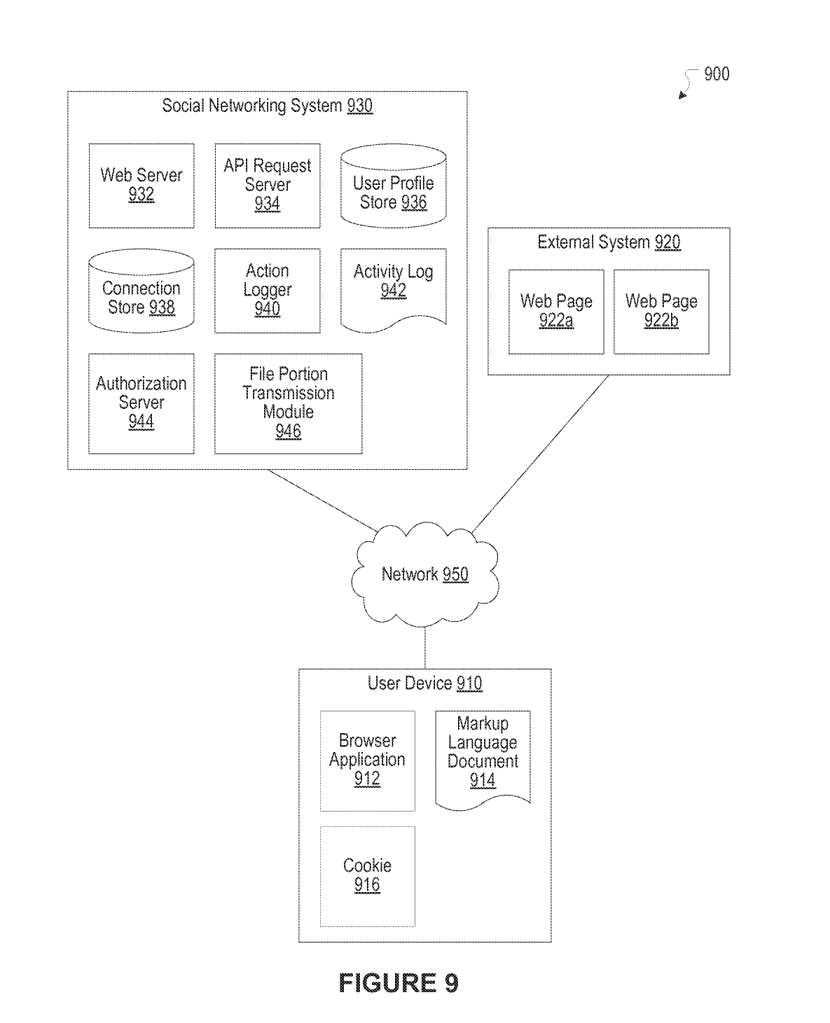

In some embodiments, it can be determined that the media file has been received entirely, for example, by the transmission complete checker module 410. The processing module 302 of FIG. 3 can transmit a message indicating that the media file has been received entirely. The processing module 302 can also receive a request to post the media file. In one example, when it is determined that the media file has been received entirely, the processing module 302 can notify the source (e.g., the client) that the transmission or uploading of the media file is complete. The source can request that the uploaded media file be posted or published, such as at a social networking system (e.g., social networking system 930 of FIG. 9) under an account associated with the source. In some embodiments, the uploaded media file, such as the video file, can be encoded prior being posted.

It should also be noted that, in some embodiments, one or more tasks, operations, and/or functions of the portion size module 402 can be performed at one or more servers, due to computational requirements or other constraints.

FIG. 5 illustrates an example validation module 502 configured to facilitate performing validations associated with transmitting a media file in multiple portions, according to an embodiment of the present disclosure. In some cases, the validation module 208 of FIG. 2 can be implemented as the example validation module 502. As shown, the example validation module 502 can include an initial request validation module 504, a portion validation module 506, a FFmpeg module 508, and a MOOV atom module 510.

The initial request validation module 504 can be configured to perform one or more validation processes with respect to an initial request to upload a media file. In some cases, the one or more validation processes with respect to the initial request can validate (e.g., check, determine, confirm, verify, etc.), based on information included in the initial request, whether or not a source has permission to upload the media file. For example, the validation process(es) can determine that the source (e.g., client, user, user account, etc.) would violate a copyright if the media file were posted and thus prevent the media file from being uploaded. In another example, the validation process(es) can determine that the source does not have permission to upload the media file with a particular tag, label, metadata, etc. In some instances, the validation process(es) can determine that the file size of the media file, the file format of the media file, the aspect ratio of the media file, and/or the playback length of the media file, etc., are not compatible. It should be appreciated that many other variations are possible.

The portion validation module 506 can be configured to perform one or more validation processes with respect to one or more media file portions. In some cases, the validation process(es) can determine whether or not a received portion is valid. For example, the validation process(es) can check whether or not the received portion has an appropriate (e.g., expected) file size, an appropriate data start position, an appropriate data end positon, a compatible format, etc. Many other variations are possible.

In some embodiments, the FFmpeg module 508 can utilize FFmpeg to facilitate performing the one or more validation processes. In some embodiments, the MOOV atom module 510 can utilize a MOOV atom of the media file (e.g., video file) to facilitate performing the one or more validation processes. In one example, the FFmpeg module 508 can utilize FFprobe (part of FFmpeg) and work in conjunction with the MOOV atom module 510 to read or access the MOOV atom of the video file. The MOOV atom of the video file can be used to determine various properties of the video file, such as length and aspect ratio. If the properties of the video file are unsupported, then there is no need to begin the uploading of the media file, thereby saving valuable resources (e.g., time, data, effort, etc.).

In some embodiments, various components of the validation module 502 can be implemented at one or more servers to which the media file is to be uploaded. As such, in some cases, one or more validation processes can be performed at the one or more servers. In some embodiments, various components of the validation module 502 can be implemented at the source (e.g., the client) that requests the media file upload. Thus, in some instances, one or more validation processes can be performed at the source.

FIG. 6 illustrates an example error handling module 602 configured to facilitate handling errors associated with transmitting a media file in multiple portions, according to an embodiment of the present disclosure. In some instances, the error handling module 210 of FIG. 2 can be implemented as the example error handling module 602. The example error handling module 602 can include an error code module 604, an error sub-code module 606, an error message module 608, an error title module 610, and a transient/permanent module 612.

The error handling module 602 can be configured to detect an error associated with a transmission of a portion of the media file. In some instances, when the error is detected, the processing module 302 of FIG. 3 can determine that a sub-portion of the portion of the media file has been received. The processing module 302 can store the sub-portion. The processing module 302 can transmit a data start position equal or subsequent to a data end position of the sub-portion. The processing module 302 can receive a remainder portion of the portion of the media file associated with the detected error. The sub-portion and the remainder portion can be combinable to produce to the portion of the media file associated with the detected error.

In some cases, the error can be associated with an error code, an error sub-code, a higher-level error message, a lower-level error message, an error title, a transient error flag, and/or a permanent error flag. The error code module 604 can access and/or provide the error code, which indicates a general alphanumerical string for the detected error. The error sub-code module 606 can access and/or provide the error sub-code, which indicates a more specific alphanumerical string for the detected error. The error message module 608 can access and/or provide the higher-level error message and/or the lower-level error message. The higher-level error message can provide a general high-level description of the error, while the lower-level error message can provide a more specific description of the error. The error title module 610 can access and/or provide the error title. The transient/permanent module 612 can access and/or provide an indication of the transient error flag and/or a permanent error flag.

In some implementations, the error handling module 602 can determine that the error associated with the transmission of the second portion is permanent. As such, a message indicating that the transmission of the second portion has incurred a permanent error can be transmitted, such as to the source. In some embodiments, the error handling module 602 can determine that the error associated with the transmission of the second portion is transient. As such, a resume request to continue uploading the media file can be received, such as from the source. An appropriate data start position and an appropriate data end position can be transmitted. The portion of the media file can be received. In some embodiments, the resume request can be received based on an exponential back-off algorithm.

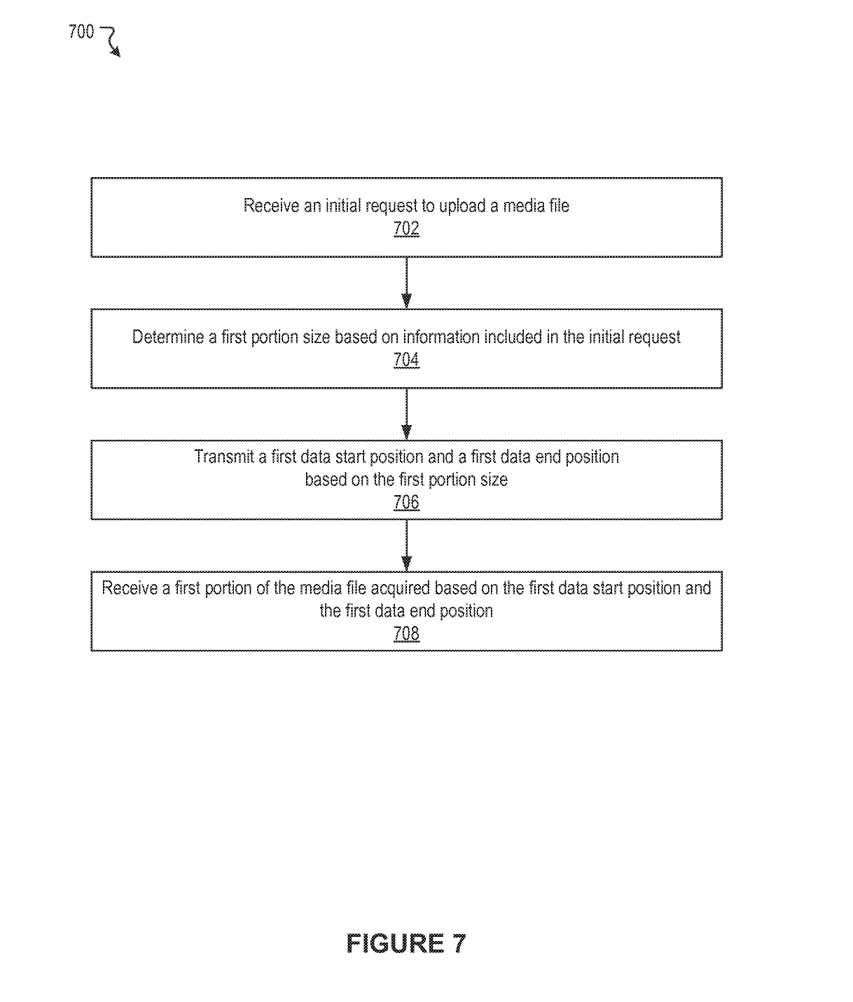

FIG. 7 illustrates an example method 700 associated with transmitting a media file in multiple portions, according to an embodiment of the present disclosure. It should be appreciated that there can be additional, fewer, or alternative steps performed in similar or alternative orders, or in parallel, within the scope of the various embodiments unless otherwise stated.

At block 702, the example method 700 can receive an initial request to upload a media file. At block 704, the example method 700 can determine a first portion size for the media file based on information included in the initial request. At block 706, the example method 700 can transmit a first data start position and a first data end position for the media file based on the first portion size. At block 708, the example method 700 can receive a first portion of the media file. In some instances, the first portion can be acquired from the media file based on the first data start position and the first data end position.

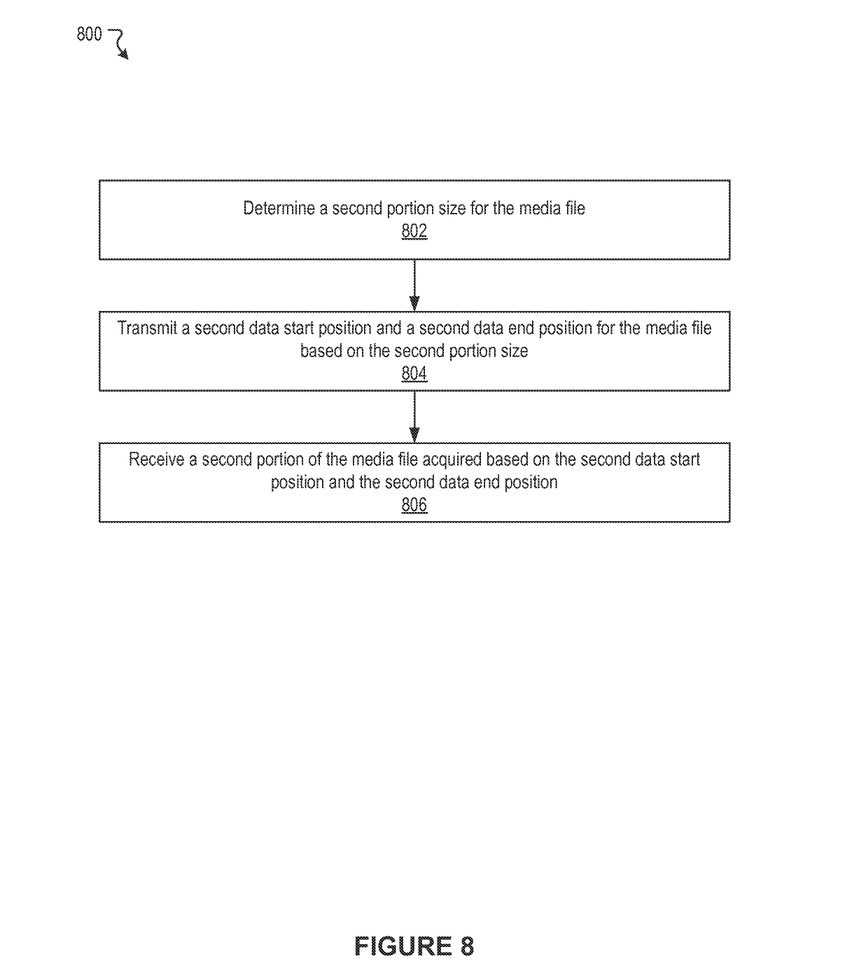

FIG. 8 illustrates an example method 800 associated with transmitting a media file in multiple portions, according to an embodiment of the present disclosure. Again, it should be appreciated that there can be additional, fewer, or alternative steps performed in similar or alternative orders, or in parallel, within the scope of the various embodiments unless otherwise stated.

At block 802, the example method 800 can determine a second portion size for the media file. At block 804, the example method 800 can transmit a second data start position and a second data end position for the media file based on the second portion size. In some cases, the second data start position can correspond to a data position in the media file equal or subsequent to the first data end position. At block 806, the example method 800 can receive a second portion of the media file. In some implementations, the second portion can be acquired from the media file based on the second data start position and the second data end position.

In some embodiments, one or more application programming interfaces (API's) associated with transmitting media files in multiple portions can be provided. In some embodiments, the transmission or uploading of media files in multiple portions can be facilitated by one or more servers, such that the source or client does not need to implement special code to enable the transmission or uploading. Moreover, in some embodiments, multiple file portions can be transmitted or uploaded in parallel.

Again, it is contemplated that there can be many other uses, applications, and/or variations associated with the various embodiments of the present disclosure. For example, various embodiments of the present disclosure can learn, improve, and/or be refined over time.

### Social Networking System—Example Implementation

FIG. 9 illustrates a network diagram of an example system 900 that can be utilized in various embodiments for enhanced video encoding, in accordance with an embodiment of the present disclosure. The system 900 includes one or more user devices 910, one or more external systems 920, a social networking system (or service) 930, and a network 950. In an embodiment, the social networking service, provider, and/or system discussed in connection with the embodiments described above may be implemented as the social networking system 930. For purposes of illustration, the embodiment of the system 900, shown by FIG. 9, includes a single external system 920 and a single user device 910. However, in other embodiments, the system 900 may include more user devices 910 and/or more external systems 920. In certain embodiments, the social networking system 930 is operated by a social network provider, whereas the external systems 920 are separate from the social networking system 930 in that they may be operated by different entities. In various embodiments, however, the social networking system 930 and the external systems 920 operate in conjunction to provide social networking services to users (or members) of the social networking system 930. In this sense, the social networking system 930 provides a platform or backbone, which other systems, such as external systems 920, may use to provide social networking services and functionalities to users across the Internet.

The user device 910 comprises one or more computing devices that can receive input from a user and transmit and receive data via the network 950. In one embodiment, the user device 910 is a conventional computer system executing, for example, a Microsoft Windows compatible operating system (OS), Apple OS X, and/or a Linux distribution. In another embodiment, the user device 910 can be a device having computer functionality, such as a smart-phone, a tablet, a personal digital assistant (PDA), a mobile telephone, etc. The user device 910 is configured to communicate via the network 950. The user device 910 can execute an application, for example, a browser application that allows a user of the user device 910 to interact with the social networking system 930. In another embodiment, the user device 910 interacts with the social networking system 930 through an application programming interface (API) provided by the native operating system of the user device 910, such as iOS and ANDROID. The user device 910 is configured to communicate with the external system 920 and the social networking system 930 via the network 950, which may comprise any combination of local area and/or wide area networks, using wired and/or wireless communication systems.

In one embodiment, the network 950 uses standard communications technologies and protocols. Thus, the network 950 can include links using technologies such as Ethernet, 702.11, worldwide interoperability for microwave access (WiMAX), 3G, 4G, CDMA, GSM, LTE, digital subscriber line (DSL), etc. Similarly, the networking protocols used on the network 950 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 950 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 910 may display content from the external system 920 and/or from the social networking system 930 by processing a markup language document 914 received from the external system 920 and from the social networking system 930 using a browser application 912. The markup language document 914 identifies content and one or more instructions describing formatting or presentation of the content. By executing the instructions included in the markup language document 914, the browser application 912 displays the identified content using the format or presentation described by the markup language document 914. For example, the markup language document 914 includes instructions for generating and displaying a web page having multiple frames that include text and/or image data retrieved from the external system 920 and the social networking system 930. In various embodiments, the markup language document 914 comprises a data file including extensible markup language (XML) data, extensible hypertext markup language (XHTML) data, or other markup language data. Additionally, the markup language document 914 may include JavaScript Object Notation (JSON) data, JSON with padding (JSONP), and JavaScript data to facilitate data-interchange between the external system 920 and the user device 910. The browser application 912 on the user device 910 may use a JavaScript compiler to decode the markup language document 914.

The markup language document 914 may also include, or link to, applications or application frameworks such as FLASH™ or Unity™ applications, the SilverLight™ application framework, etc.

In one embodiment, the user device 910 also includes one or more cookies 916 including data indicating whether a user of the user device 910 is logged into the social networking system 930, which may enable modification of the data communicated from the social networking system 930 to the user device 910.

The external system 920 includes one or more web servers that include one or more web pages 922a, 922b, which are communicated to the user device 910 using the network 950. The external system 920 is separate from the social networking system 930. For example, the external system 920 is associated with a first domain, while the social networking system 930 is associated with a separate social networking domain. Web pages 922a, 922b, included in the external system 920, comprise markup language documents 914 identifying content and including instructions specifying formatting or presentation of the identified content.

The social networking system 930 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 930 may be administered, managed, or controlled by an operator. The operator of the social networking system 930 may be a human being, an automated application, or a series of applications for managing content, regulating policies, and collecting usage metrics within the social networking system 930. Any type of operator may be used.

Users may join the social networking system 930 and then add connections to any number of other users of the social networking system 930 to whom they desire to be connected. As used herein, the term “friend” refers to any other user of the social networking system 930 to whom a user has formed a connection, association, or relationship via the social networking system 930. For example, in an embodiment, if users in the social networking system 930 are represented as nodes in the social graph, the term “friend” can refer to an edge formed between and directly connecting two user nodes.

Connections may be added explicitly by a user or may be automatically created by the social networking system 930 based on common characteristics of the users (e.g., users who are alumni of the same educational institution). For example, a first user specifically selects a particular other user to be a friend. Connections in the social networking system 930 are usually in both directions, but need not be, so the terms “user” and “friend” depend on the frame of reference. Connections between users of the social networking system 930 are usually bilateral (“two-way”), or “mutual,” but connections may also be unilateral, or “one-way.” For example, if Bob and Joe are both users of the social networking system 930 and connected to each other, Bob and Joe are each other's connections. If, on the other hand, Bob wishes to connect to Joe to view data communicated to the social networking system 930 by Joe, but Joe does not wish to form a mutual connection, a unilateral connection may be established. The connection between users may be a direct connection; however, some embodiments of the social networking system 930 allow the connection to be indirect via one or more levels of connections or degrees of separation.

In addition to establishing and maintaining connections between users and allowing interactions between users, the social networking system 930 provides users with the ability to take actions on various types of items supported by the social networking system 930. These items may include groups or networks (i.e., social networks of people, entities, and concepts) to which users of the social networking system 930 may belong, events or calendar entries in which a user might be interested, computer-based applications that a user may use via the social networking system 930, transactions that allow users to buy or sell items via services provided by or through the social networking system 930, and interactions with advertisements that a user may perform on or off the social networking system 930. These are just a few examples of the items upon which a user may act on the social networking system 930, and many others are possible. A user may interact with anything that is capable of being represented in the social networking system 930 or in the external system 920, separate from the social networking system 930, or coupled to the social networking system 930 via the network 950.

The social networking system 930 is also capable of linking a variety of entities. For example, the social networking system 930 enables users to interact with each other as well as external systems 920 or other entities through an API, a web service, or other communication channels. The social networking system 930 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 930. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 930 modifies edges connecting the various nodes to reflect the relationships and interactions.

The social networking system 930 also includes user-generated content, which enhances a user's interactions with the social networking system 930. User-generated content may include anything a user can add, upload, send, or “post” to the social networking system 930. For example, a user communicates posts to the social networking system 930 from a user device 910. Posts may include data such as status updates or other textual data, location information, images such as photos, videos, links, music or other similar data and/or media. Content may also be added to the social networking system 930 by a third party. Content “items” are represented as objects in the social networking system 930. In this way, users of the social networking system 930 are encouraged to communicate with each other by posting text and content items of various types of media through various communication channels. Such communication increases the interaction of users with each other and increases the frequency with which users interact with the social networking system 930.

The social networking system 930 includes a web server 932, an API request server 934, a user profile store 936, a connection store 938, an action logger 940, an activity log 942, and an authorization server 944. In an embodiment of the invention, the social networking system 930 may include additional, fewer, or different components for various applications. Other components, such as network interfaces, security mechanisms, load balancers, failover servers, management and network operations consoles, and the like are not shown so as to not obscure the details of the system.

The user profile store 936 maintains information about user accounts, including biographic, demographic, and other types of descriptive information, such as work experience, educational history, hobbies or preferences, location, and the like that has been declared by users or inferred by the social networking system 930. This information is stored in the user profile store 936 such that each user is uniquely identified. The social networking system 930 also stores data describing one or more connections between different users in the connection store 938. The connection information may indicate users who have similar or common work experience, group memberships, hobbies, or educational history. Additionally, the social networking system 930 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 930, such as non-person entities, buckets, cluster centers, images, interests, pages, external systems, concepts, and the like are also stored in the connection store 938.

The social networking system 930 maintains data about objects with which a user may interact. To maintain this data, the user profile store 936 and the connection store 938 store instances of the corresponding type of objects maintained by the social networking system 930. Each object type has information fields that are suitable for storing information appropriate to the type of object. For example, the user profile store 936 contains data structures with fields suitable for describing a user's account and information related to a user's account. When a new object of a particular type is created, the social networking system 930 initializes a new data structure of the corresponding type, assigns a unique object identifier to it, and begins to add data to the object as needed. This might occur, for example, when a user becomes a user of the social networking system 930, the social networking system 930 generates a new instance of a user profile in the user profile store 936, assigns a unique identifier to the user account, and begins to populate the fields of the user account with information provided by the user.

The connection store 938 includes data structures suitable for describing a user's connections to other users, connections to external systems 920 or connections to other entities. The connection store 938 may also associate a connection type with a user's connections, which may be used in conjunction with the user's privacy setting to regulate access to information about the user. In an embodiment of the invention, the user profile store 936 and the connection store 938 may be implemented as a federated database.

Data stored in the connection store 938, the user profile store 936, and the activity log 942 enables the social networking system 930 to generate the social graph that uses nodes to identify various objects and edges connecting nodes to identify relationships between different objects. For example, if a first user establishes a connection with a second user in the social networking system 930, user accounts of the first user and the second user from the user profile store 936 may act as nodes in the social graph. The connection between the first user and the second user stored by the connection store 938 is an edge between the nodes associated with the first user and the second user. Continuing this example, the second user may then send the first user a message within the social networking system 930. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 930 (or, alternatively, in an image maintained by another system outside of the social networking system 930). The image may itself be represented as a node in the social networking system 930. This tagging action may create edges between the first user and the second user as well as create an edge between each of the users and the image, which is also a node in the social graph. In yet another example, if a user confirms attending an event, the user and the event are nodes obtained from the user profile store 936, where the attendance of the event is an edge between the nodes that may be retrieved from the activity log 942. By generating and maintaining the social graph, the social networking system 930 includes data describing many different types of objects and the interactions and connections among those objects, providing a rich source of socially relevant information.

The web server 932 links the social networking system 930 to one or more user devices 910 and/or one or more external systems 920 via the network 950. The web server 932 serves web pages, as well as other web-related content, such as Java, JavaScript, Flash, XML, and so forth. The web server 932 may include a mail server or other messaging functionality for receiving and routing messages between the social networking system 930 and one or more user devices 910. The messages can be instant messages, queued messages (e.g., email), text and SMS messages, or any other suitable messaging format.

The API request server 934 allows one or more external systems 920 and user devices 910 to call access information from the social networking system 930 by calling one or more API functions. The API request server 934 may also allow external systems 920 to send information to the social networking system 930 by calling APIs. The external system 920, in one embodiment, sends an API request to the social networking system 930 via the network 950, and the API request server 934 receives the API request. The API request server 934 processes the request by calling an API associated with the API request to generate an appropriate response, which the API request server 934 communicates to the external system 920 via the network 950. For example, responsive to an API request, the API request server 934 collects data associated with a user, such as the user's connections that have logged into the external system 920, and communicates the collected data to the external system 920.

In another embodiment, the user device 910 communicates with the social networking system 930 via APIs in the same manner as external systems 920.

The action logger 940 is capable of receiving communications from the web server 932 about user actions on and/or off the social networking system 930. The action logger 940 populates the activity log 942 with information about user actions, enabling the social networking system 930 to discover various actions taken by its users within the social networking system 930 and outside of the social networking system 930. Any action that a particular user takes with respect to another node on the social networking system 930 may be associated with each user's account, through information maintained in the activity log 942 or in a similar database or other data repository. Examples of actions taken by a user within the social networking system 930 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 930, the action is recorded in the activity log 942. In one embodiment, the social networking system 930 maintains the activity log 942 as a database of entries. When an action is taken within the social networking system 930, an entry for the action is added to the activity log 942. The activity log 942 may be referred to as an action log.

Additionally, user actions may be associated with concepts and actions that occur within an entity outside of the social networking system 930, such as an external system 920 that is separate from the social networking system 930. For example, the action logger 940 may receive data describing a user's interaction with an external system 920 from the web server 932. In this example, the external system 920 reports a user's interaction according to structured actions and objects in the social graph.

Other examples of actions where a user interacts with an external system 920 include a user expressing an interest in an external system 920 or another entity, a user posting a comment to the social networking system 930 that discusses an external system 920 or a web page 922a within the external system 920, a user posting to the social networking system 930 a Uniform Resource Locator (URL) or other identifier associated with an external system 920, a user attending an event associated with an external system 920, or any other action by a user that is related to an external system 920. Thus, the activity log 942 may include actions describing interactions between a user of the social networking system 930 and an external system 920 that is separate from the social networking system 930.

The authorization server 944 enforces one or more privacy settings of the users of the social networking system 930. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 920, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 920. One embodiment allows the specification of the set of entities to comprise an enumeration of entities. For example, the user may provide a list of external systems 920 that are allowed to access certain information. Another embodiment allows the specification to comprise a set of entities along with exceptions that are not allowed to access the information. For example, a user may allow all external systems 920 to access the user's work information, but specify a list of external systems 920 that are not allowed to access the work information. Certain embodiments call the list of exceptions that are not allowed to access certain information a “block list”. External systems 920 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 944 contains logic to determine if certain information associated with a user can be accessed by a user's friends, external systems 920, and/or other applications and entities. The external system 920 may need authorization from the authorization server 944 to access the user's more private and sensitive information, such as the user's work phone number. Based on the user's privacy settings, the authorization server 944 determines if another user, the external system 920, an application, or another entity is allowed to access information associated with the user, including information about actions taken by the user.

In some embodiments, the social networking system 930 can include a file portion transmission module 946. The file portion transmission module 946 can, for example, be implemented as the file portion transmission module 106 of FIG. 1 and/or the file portion transmission module 202 of FIG. 2. The file portion transmission module 946 can be configured to receive an initial request to upload a media file. The file portion transmission module 946 can also be configured to determine a first portion size for the media file based on information included in the initial request. Further, the file portion transmission module 946 can be configured to transmit a first data start position and a first data end position for the media file based on the first portion size. Moreover, the file portion transmission module 946 can be configured to receive a first portion of the media file. In some cases, the first portion can be acquired from the media file based on the first data start position and the first data end position. Other features of the file portion transmission module 946 are discussed herein in connection with the file portion transmission module 106 and/or the file portion transmission module 202.

### Hardware Implementation

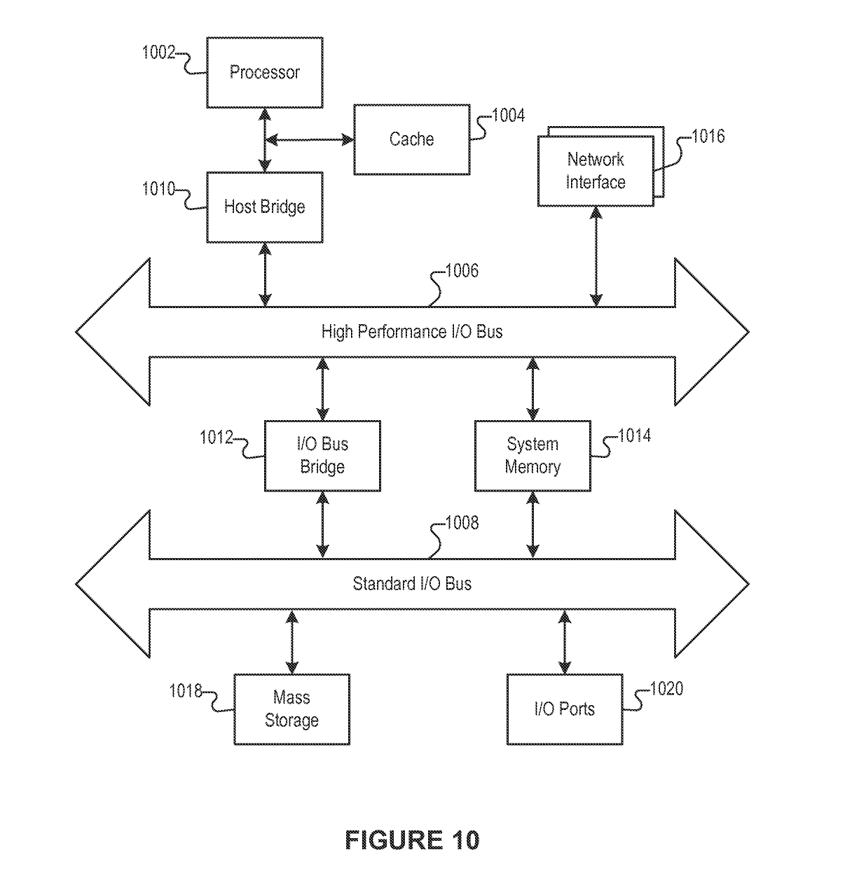

The foregoing processes and features can be implemented by a wide variety of machine and computer system architectures and in a wide variety of network and computing environments. FIG. 10 illustrates an example of a computer system 1000 that may be used to implement one or more of the embodiments described herein in accordance with an embodiment of the invention. The computer system 1000 includes sets of instructions for causing the computer system 1000 to perform the processes and features discussed herein. The computer system 1000 may be connected (e.g., networked) to other machines. In a networked deployment, the computer system 1000 may operate in the capacity of a server machine or a client machine in a client-server network environment, or as a peer machine in a peer-to-peer (or distributed) network environment. In an embodiment of the invention, the computer system 1000 may be the social networking system 1030, the user device 910, and the external system 1020, or a component thereof. In an embodiment of the invention, the computer system 1000 may be one server among many that constitutes all or part of the social networking system 1030.

The computer system 1000 includes a processor 1002, a cache 1004, and one or more executable modules and drivers, stored on a computer-readable medium, directed to the processes and features described herein. Additionally, the computer system 1000 includes a high performance input/output (I/O) bus 1006 and a standard I/O bus 1008. A host bridge 1010 couples processor 1002 to high performance I/O bus 1006, whereas I/O bus bridge 1012 couples the two buses 1006 and 1008 to each other. A system memory 1014 and one or more network interfaces 1016 couple to high performance I/O bus 1006. The computer system 1000 may further include video memory and a display device coupled to the video memory (not shown). Mass storage 1018 and I/O ports 1020 couple to the standard I/O bus 1008. The computer system 1000 may optionally include a keyboard and pointing device, a display device, or other input/output devices (not shown) coupled to the standard I/O bus 1008. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 1000, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 1000 are described in greater detail below. In particular, the network interface 1016 provides communication between the computer system 1000 and any of a wide range of networks, such as an Ethernet (e.g., IEEE 802.3) network, a backplane, etc. The mass storage 1018 provides permanent storage for the data and programming instructions to perform the above-described processes and features implemented by the respective computing systems identified above, whereas the system memory 1014 (e.g., DRAM) provides temporary storage for the data and programming instructions when executed by the processor 1002. The I/O ports 1020 may be one or more serial and/or parallel communication ports that provide communication between additional peripheral devices, which may be coupled to the computer system 1000.

The computer system 1000 may include a variety of system architectures, and various components of the computer system 1000 may be rearranged. For example, the cache 1004 may be on-chip with processor 1002. Alternatively, the cache 1004 and the processor 1002 may be packed together as a “processor module”, with processor 1002 being referred to as the “processor core”. Furthermore, certain embodiments of the invention may neither require nor include all of the above components. For example, peripheral devices coupled to the standard I/O bus 1008 may couple to the high performance I/O bus 1006. In addition, in some embodiments, only a single bus may exist, with the components of the computer system 1000 being coupled to the single bus. Moreover, the computer system 1000 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 1000 that, when read and executed by one or more processors, cause the computer system 1000 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 1000, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 1002. Initially, the series of instructions may be stored on a storage device, such as the mass storage 1018. However, the series of instructions can be stored on any suitable computer readable storage medium. Furthermore, the series of instructions need not be stored locally, and could be received from a remote storage device, such as a server on a network, via the network interface 1016. The instructions are copied from the storage device, such as the mass storage 1018, into the system memory 1014 and then accessed and executed by the processor 1002. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 1000 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by a computing system, an initial request to upload a media file;
determining, by the computing system, a first portion size for the media file based on information included in the initial request;
transmitting, by the computing system, a first data start position and a first data end position for the media file based on the first portion size; and
receiving, by the computing system, a first portion of the media file, the first portion being acquired from the media file based on the first data start position and the first data end position.

2. The computer-implemented method of claim 1, wherein the information included in the initial request comprises at least one of a file size of the media file, a network condition, historical usage data, or a property associated with a source requesting to upload the media file.

3. The computer-implemented method of claim 2, wherein the network condition indicates bandwidth, wherein the first portion size for the media file is increased when the bandwidth increases, and wherein the first portion size for the media file is decreased when the bandwidth decreases.

4. The computer-implemented method of claim 2, wherein the first portion size is determined based on historical usage data including information about a portion size during a previous file upload.

5. The computer-implemented method of claim 2, wherein the property associated with the source includes at least one of a property about an operating system of the source or a property about an application running on the source.

6. The computer-implemented method of claim 1, further comprising:
determining a second portion size for the media file;
transmitting a second data start position and a second data end position for the media file based on the second portion size, the second data start position corresponding to a data position in the media file equal or subsequent to the first data end position; and
receiving a second portion of the media file, the second portion being acquired from the media file based on the second data start position and the second data end position.

7. The computer-implemented method of claim 6, further comprising:
performing one or more validation processes for at least one of the initial request, the first portion of the media file, or the second portion of the media file.

8. The computer-implemented method of claim 7, wherein the one or more validation processes are performed at a source requesting to upload the media file.

9. The computer-implemented method of claim 7, wherein the one or more validation processes utilize at least one of a feature associated with FFmpeg or a MOOV atom of the media file.

10. The computer-implemented method of claim 6, further comprising:
determining that the media file has been received entirely;
transmitting a message indicating that the media file has been received entirely; and
receiving a request to post the media file.

11. The computer-implemented method of claim 10, further comprising:
encoding the media file; and
posting the media file at a social networking system under an account associated with a source requesting to upload the media file.

12. The computer-implemented method of claim 1, further comprising:
determining a second portion size for the media file;
transmitting a second data start position and a second data end position for the media file based on the second portion size, the second data start position corresponding to a data position in the media file equal or subsequent to the first data end position; and
detecting an error associated with a transmission of the second portion of the media file.

13. The computer-implemented method of claim 12, further comprising:
determining that a sub-portion of the second portion of the media file has been received;
storing the sub-portion of the second portion of the media file;
transmitting a third data start position equal or subsequent to a data end position of the sub-portion; and
receiving a remainder portion of the second portion of the media file, wherein the sub-portion and the remainder portion are combinable to produce to the second portion of the media file.

14. The computer-implemented method of claim 12, wherein the error is associated with at least one of an error code, an error sub-code, an error message, an error title, a transient error flag, or a permanent error flag.

15. The computer-implemented method of claim 12, further comprising:
determining that the error associated with the transmission of the second portion is permanent; and
transmitting a message indicating that the transmission of the second portion has incurred a permanent error.

16. The computer-implemented method of claim 12, further comprising:
determining that the error associated with the transmission of the second portion is transient;
receiving a resume request to continue uploading the media file;
transmitting the second data start position and the second data end position; and
receiving the second portion of the media file.

17. The computer-implemented method of claim 16, wherein the resume request is received based on an exponential back-off algorithm.

18. The computer-implemented method of claim 1, wherein the media file includes at least one of a video file, an image file, an audio file, or a media software file.

19. A system comprising:
at least one processor; and
a memory storing instructions that, when executed by the at least one processor, cause the system to perform:
receiving an initial request to upload a media file;
determining a first portion size for the media file based on information included in the initial request;
transmitting a first data start position and a first data end position for the media file based on the first portion size; and
receiving a first portion of the media file, the first portion being acquired from the media file based on the first data start position and the first data end position.

20. A non-transitory computer-readable storage medium including instructions that, when executed by at least one processor of a computing system, cause the computing system to perform:
receiving an initial request to upload a media file;
determining a first portion size for the media file based on information included in the initial request;
transmitting a first data start position and a first data end position for the media file based on the first portion size; and
receiving a first portion of the media file, the first portion being acquired from the media file based on the first data start position and the first data end position.
